(19) United States
(12) Patent Application Publication
(10) Pub. No.: US 2025/0187674 A1
(43) Pub. Date: Jun. 12, 2025

(54) BODY OF VEHICLE

(71) Applicants: Hyundai Motor Company, Seoul (KR); Kia Corporation, Seoul (KR)

(72) Inventors: Seung Min Jeong, Hwaseong-si (KR); Joo Nam Kim, Seoul (KR)

(21) Appl. No.: 18/659,655

(22) Filed: May 9, 2024

(30) Foreign Application Priority Data
Dec. 8, 2023 (KR) 10-2023-0177707

(51) Int. Cl. B62D 25/20; B60K 1/04; B60N 2/005; B62D 21/15; B62D 25/02; B62D 27/02; H01M 50/204; H01M 50/242; H01M 50/249; H01M 50/258

(52) U.S. Cl. CPC B62D 25/2036; B62D 25/025; B62D 27/023; H01M 50/204; H01M 50/242; H01M 50/249; H01M 50/258; B60K 1/04; B60K 2001/0438; B60N 2/005; B62D 21/157; H01M 2220/20

(57) ABSTRACT

An embodiment body of a vehicle includes a floor part configured as a member molded through an extrusion process, the floor part having a lower surface configured to cover upper portions of battery modules to be accommodated in a lower battery case and a pair of side sills coupled to opposite side surfaces of the floor part and extending in a longitudinal direction of the vehicle, each side sill of the pair of side sills comprising a first flange disposed at an inner surface of the side sill facing the floor part and extending in the longitudinal direction, wherein the first flange is directly coupled to the lower surface of the floor part by a first weld.

### CROSS-REFERENCE TO RELATED APPLICATIONS

This application claims the benefit of Korean Patent Application No. 10-2023-0177707, filed on Dec. 8, 2023, which application is hereby incorporated herein by reference in its entirety.

### TECHNICAL FIELD

The present invention relates to a body of a vehicle.

### BACKGROUND

In an electric vehicle, an extension in the range thereof is an important development target. As schemes for extending the range of the electric vehicle, there are an increase in battery capacity through an increase in the number of battery cells, weight reduction of parts of the electric vehicle, etc. However, an increase in battery capacity through an increase in the number of battery cells inevitably involves an increase in the weight of battery cells. In this case, accordingly, there is a limitation in extending the range.

Many manufacturers concentrate on a scheme for maximally mounting battery cells by maximally efficiently using a limited space of a vehicle while reducing the weight of a battery system itself or reducing the weight of the vehicle.

Meanwhile, a battery of an electric vehicle is mounted at a lower part of a vehicle body. In detail, the battery is mounted at the lower part of the vehicle body under the condition that a plurality of battery modules is accommodated in a battery case in a state of being connected to one another. In association with this, technology for accommodating battery modules in a lower battery case and enabling a vehicle body floor to function as an upper battery case while omitting such an upper battery case is being developed.

The above matters disclosed in this section are merely for enhancement of understanding of the general background of the invention and should not be taken as an acknowledgement or any form of suggestion that the matters form the already known prior art.

### SUMMARY

The present invention relates to a body of a vehicle. Particular embodiments relate to a coupling structure between a floor constituting a lower vehicle part in a body of the vehicle and a side sill.

Therefore, embodiments of the present invention have been made in view of problems in the art, and an embodiment of the present invention provides a body of a vehicle including a floor part capable of functioning as an upper battery case and a coupling structure between the floor part and a side sill, a battery watertight/airtight maintaining structure, etc. for implementation of the vehicle body.

In accordance with embodiments of the present invention, the above and other features can be accomplished by the provision of a body of a vehicle including a floor part configured as a member molded through an extrusion process, to constitute a floor of the vehicle, the floor part having a lower surface configured to cover upper portions of battery modules accommodated in a lower battery case, thereby functioning as an upper battery case, and a side sill coupled to opposite side surfaces of the floor part while extending in a longitudinal direction of the vehicle, the side sill including a first flange formed at an inner surface of the side sill facing the floor part while extending in a longitudinal direction, the first flange being welded to the lower surface of the floor part in a state of contacting the lower surface of the floor part.

The lower surface of the floor part and the first flange of the side sill may be coupled to each other in the longitudinal direction of the first flange through friction stir spot welding (FSW) in a surface-contact state.

An area between an upper surface of the floor part and an upper surface of the side sill contacting each other may be welded through metal inert gas (MIG) welding.

Portions of an upper surface of the side sill and an upper surface of the floor part may be interconnected through a reinforcement.

The reinforcement may take a form of a member having a closed cross-section while extending in a predetermined length. A lower surface of the reinforcement may be coupled to both the upper surface of the side sill and the upper surface of the floor part. One side surface of the reinforcement may surface-contact the side sill, to be supported by the side sill, thereby reinforcing hardness against side collision.

The upper surface of the floor part may be formed to be lower than the upper surface of the side sill when viewed in a height direction. The lower surface of the reinforcement may tightly contact the upper surface of the side sill and the upper surface of the floor part disposed at different levels by a step.

The floor part may be extruded in a width direction of the vehicle. Barrier walls extending downwards may be formed at front and rear ends of the floor part, to be integrated with the floor part, respectively. The downwardly extending barrier walls cover side surfaces of outermost ones of the battery modules.

An extension protruding in a downward direction of the vehicle may be formed at the lower surface of the floor part in an area corresponding to an edge of the floor part such that the first flange and the lower surface of the floor part adjacent to the first flange are flush with each other.

The extension may have a thickness equal to a thickness of the first flange of the side sill.

Welding between the first flange of the side sill and the lower surface of the floor part may be started from the extension of the floor part.

A rear end of the floor part may have a trapezoidal shape. A seam may be welded to the rear end of the floor part at an edge of the floor part. A second flange may be formed at an inner surface of the seam facing the floor part. The second flange may be welded to the lower surface of the floor part in a state of contacting the lower surface of the floor part.

Extensions protruding in a downward direction of the vehicle may be formed at the lower surface of the floor part in areas corresponding to edges of the floor part, respectively. One of the extensions formed at the front end of the floor part may have a lower surface flush with the lower surface of the floor part of the side sill. Another one of the extensions formed at the rear end of the floor part may have a lower surface flush with a lower surface of the second flange of the seam.

A thickness of the second flange, a thickness of the extension formed at the rear-end edge of the floor part, and a thickness of the first flange of the side sill may be equal.

Welding between the first flange of the side sill and the lower surface of the floor part may be started from the front-end extension of the floor part and may be ended at the rear-end extension of the floor part.

An area between the seam and the side sill contacting each other and an area between the seam and a barrier wall of the floor part may be welded through metal inert gas (MIG) welding. The lower surface of the floor part and the second flange may be welded to each other through friction stir spot welding.

The floor part may include a plurality of extruded members extruded in a width direction of the vehicle.

The plurality of extruded members may be aligned with one another in the longitudinal direction of the vehicle. Adjacent ones of the extruded members may be welded to each other through friction stir spot welding in a state of surface-contacting each other, thereby forming the floor part.

The plurality of extruded members may include a first extruded member, a second extruded member, and a third extruded member respectively having different heights. A seat mounting for mounting of a seat may be formed at the first extruded member extending upwards to a higher level than levels of the second and third extruded members. The third extruded member extending downwards to a lower level than levels of the first and second extruded members may be disposed at front and rear ends of the floor part, thereby forming a space at the lower surface of the floor part.

### BRIEF DESCRIPTION OF THE DRAWINGS

The above and other objects, features, and other advantages of embodiments of the present invention will be more clearly understood from the following detailed description taken in conjunction with the accompanying drawings, in which:

FIG. 1 shows mounting of a battery at a lower side;

FIGS. 2 and 3 are views showing a cross-section of a body of a vehicle according to an embodiment of the present invention;

FIG. 4 shows a lower surface of the body of the vehicle according to an embodiment of the present invention;

FIG. 5 shows an enlarged view of a rear end of a floor part; and

FIG. 6 shows a cross-section taken in a longitudinal direction of the vehicle.

### DETAILED DESCRIPTION OF ILLUSTRATIVE EMBODIMENTS

Hereinafter, embodiments of the present invention will be described in detail with reference to the accompanying drawings, and the same or similar elements are designated by the same reference numerals throughout the figures and redundant description thereof will be omitted.

In the following description of the embodiments of the present invention, a detailed description of known functions and configurations incorporated herein will be omitted when it may obscure the subject matter of the embodiments of the present invention. In addition, the embodiments of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that, although the terms “first,” “second,” etc. may be used herein to describe various elements, these elements should not be limited by these terms. These terms are only used to distinguish one element from another.

Unless clearly used otherwise, singular expressions include a plural meaning.

In this specification, the term “comprising,” “including,” or the like is intended to express the existence of the characteristic, the numeral, the step, the operation, the element, the part, or the combination thereof, and does not exclude another characteristic, numeral, step, operation, element, part, or any combination thereof, or any addition thereto.

In the case where an element is “connected” or “linked” to another element, it should be understood that the element may be directly connected or linked to the other element or another element may be present therebetween. Conversely, in the case where an element is “directly connected” or “directly linked” to another element, it should be understood that no other element is present therebetween.

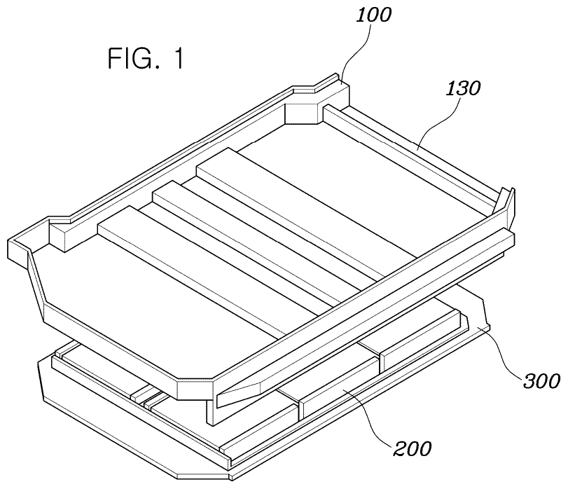

FIG. 1 shows mounting of a battery at a lower side. Referring to FIG. 1, the battery is mounted at a lower portion of a floor part 130 constituting a floor 100 of a vehicle. In detail, an accommodation space for accommodating battery modules 200 therein may be provided at a lower battery case 300, and the lower battery case 300 may be coupled to a vehicle body under the floor part 130 of the vehicle.

That is, in a conventional battery, battery modules thereof are mounted in a lower battery case, an upper battery case is coupled to the lower battery case, and the resultant structure is coupled to a vehicle body. On the other hand, in embodiments of the present invention, the lower battery case 300, in which the battery modules 200 are accommodated, may be coupled to the vehicle body while omitting an upper battery case.

Since a battery is electronic equipment, the battery should be isolated from an external environment as much as possible. For this reason, in conventional cases, a sealer is coated on the battery in order to block water or foreign matter introduced from outside the vehicle body. However, the sealer is insufficient to secure airtightness and watertightness of a perfect level. In particular, the seal may have difficulty securing high-pressure watertight performance.

In all electric vehicles, securing airtightness and watertightness of a perfect-level is required. In particular, in embodiments of the present invention in which an upper battery case is omitted, such a requirement is very great.

In order to secure airtightness and watertightness of a perfect-level, embodiments of the present invention propose securing airtightness and watertightness through coupling of parts by welding while minimizing use of a sealer.

Hereinafter, a coupling structure between the floor part 130 and a side sill 150 for securing airtightness and watertightness will be described.

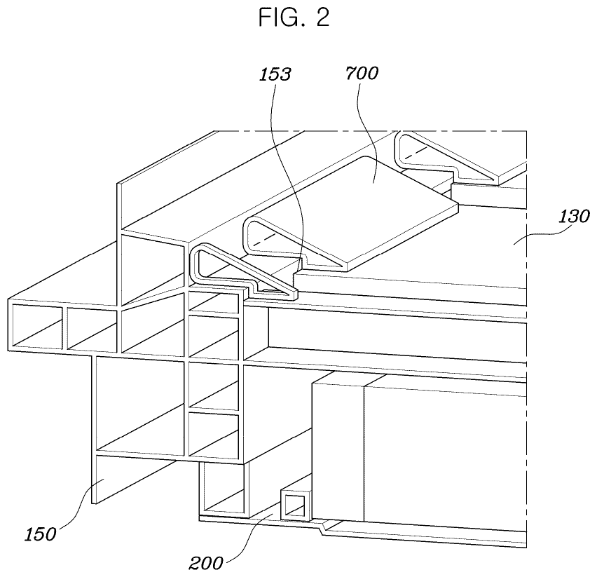

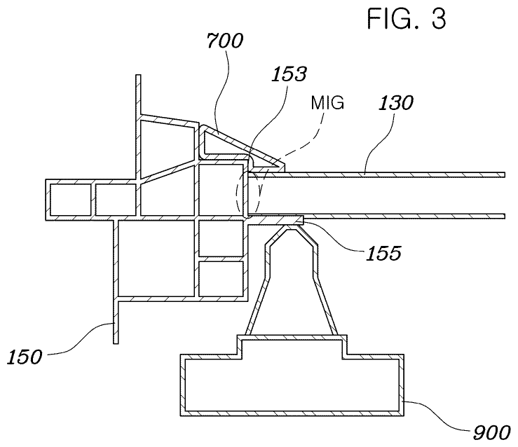

FIGS. 2 and 3 are views showing a cross-section of a vehicle body according to an embodiment of the present invention. Referring to FIGS. 2 and 3, the side sill 150 and the floor part 130 are coupled to each other, thereby constituting the floor 100 of the vehicle.

In detail, the floor part 130 is made of an aluminum material and is molded through an extrusion process to take the form of a member. The floor part 130, which takes the form of a member, has an upper surface and a lower surface. A seat mounting, to which a seat will be coupled, may be formed at the upper surface of the floor part 130. The lower surface of the floor part 130 covers upper portions of the battery modules 200 accommodated in the lower battery case 300 and, as such, the floor part 130 may function as an upper battery case.

In addition, since the floor part 130 takes the form of a member, the floor part 130 may have an effect of a multi-channel structure capable of distributing a load when side collision of the vehicle occurs.

The side sill 150 extends in a longitudinal direction of the vehicle and is coupled to opposite side surfaces of the floor part 130. In order to protect the battery in a side collision of the vehicle, the side sill 150 may have a plurality of closed cross-sections.

Meanwhile, for coupling between the side sill 150 and the floor part 130, a first flange 155 extending in a longitudinal direction is formed at an inner surface of the side sill 150 facing the floor part 130. When the side sill 150 is disposed at the floor part 130 in order to couple the side sill 150 to the floor part 130, the first flange 155 of the side sill 150 is disposed at the lower surface of the floor part 130.

In a state in which the lower surface of the floor part 130 and the first flange 155 of the side sill 150 surface-contact each other, a welding machine 900 welds the first flange 155 and the lower surface of the floor part 130 to each other under the floor part 130. The welding machine 900 welds the side sill 150 and the floor part 130 in a longitudinal direction of the first flange 155. It is preferred that the welding method used in this case be friction stir spot welding (FSW).

In order to use the floor part 130 as an upper battery case, a structure capable of securing watertightness and airtightness when the side sill 150 and the floor part 130 are coupled to each other is needed. In association with this, the first flange 155 is formed at the side sill 150, and the lower surface of the floor part 130 and the first flange 155 are welded to each other and, as such, watertightness and airtightness may be secured.

The first flange 155 and the lower surface of the floor part 130 surface-contacting each other are welded to each other through friction stir spot welding, whereas an area between the upper surface of the floor part 130 and an upper surface of the side sill 150 contacting each other is welded through metal inert gas (MIG) welding. Accordingly, coupling between the floor part 130 and the side sill 150 may be further strengthened.

That is, a seat mounting is formed at the upper surface of the floor part 130. Since parts other than the side sill 150 may be coupled to the seat mounting, the upper surface of the floor part 130 may be formed to be curved, differently from the lower surface of the floor part 130. For this reason, it is preferred that the upper surface of the floor part 130 be welded through MIG welding.

As the floor part 130 and the side sill 150 are welded to each other, as described above, it may be possible to suppress introduction of foreign matter from the outside into the interior of the battery.

Meanwhile, the side sill 150 is welded to the floor part 130 in a longitudinal direction of the vehicle and, as such, airtightness and watertightness at a side of the vehicle are secured.

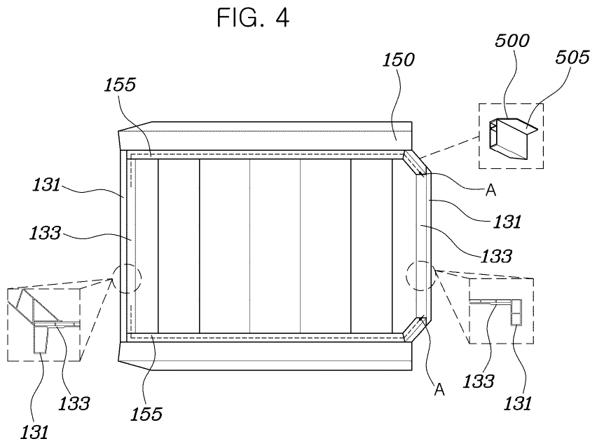

Barrier walls 131 (FIG. 4) extending downwards are formed at front and rear ends of the floor part 130, respectively, together with the floor part 130 when the floor part 130 is extruded. By virtue of the barrier walls 131 formed at the front and rear ends of the floor part 130, airtightness and watertightness may also be secured at front and rear sides of the vehicle.

FIG. 4 shows a lower surface of the vehicle body of the vehicle according to an embodiment of the present invention. Referring to FIG. 4, the barrier walls 131 extending downwards are formed at the front and rear ends of the floor part 130, respectively.

The barrier walls 131 may cover side surfaces of the battery modules 200, and the lower surface of the floor part 130 may cover the upper portions of the battery modules 200. Accordingly, the floor part 130 may function as an upper battery case.

In particular, since airtightness and watertightness at the front and rear ends of the floor part 130 are secured as the barrier walls 131 are integrally formed at the floor part 130, maintenance of airtightness and watertightness for the battery is satisfied only through welding of the side sill 150 to the floor part 130.

That is, if a separate part for maintenance of airtightness and watertightness at the front and rear ends of the floor part 130 is introduced without formation of the barrier walls 131 at the floor part 130, it is necessary to perform welding along the entirety of the periphery of the floor part 130 and, as such, time and costs are increased. However, when the barrier walls 131 are integrally formed at the floor part 130, only welding of the side sill 150 is necessary.

Meanwhile, as the first flange 155 of the side sill 150 and the lower surface of the floor part 130 are welded to each other, coupling between the side sill 150 and the first flange 155 is achieved. Although welding carried out from a front end of the first flange 155 to a rear end of the first flange 155 is sufficient for coupling between the side sill 150 and the floor part 130, it is preferred that the welding be started from a side portion of the first flange 155, for perfect airtightness and watertightness.

That is, referring to a welding position A between the first flange 155 and the lower surface of the floor part 130 shown in FIG. 4, welding may be started from the side portion of the first flange 155, for airtightness and watertightness.

For friction stir spot welding, the first flange 155 and the side portion of the first flange 155, that is, the lower surface of the floor part 130 adjacent to the first flange 155, should be flush with each other. In order to enable the first flange 155 and the lower surface of the floor part 130 adjacent to the first flange 155 to be flush with each other, an extension 133 protruding in a downward direction of the vehicle may be formed at the lower surface of the floor part 130 in an area corresponding to an edge of the floor part 130.

The extension 133 is formed adjacent to each barrier wall 131 and protrudes downwards, as shown in FIG. 4, differently from the lower surface of the floor part 130 adjacent to the extension 133. That is, since the first flange 155 is provided at the side sill 150, for friction stir spot welding between the side sill 150 and the floor part 130, the first flange 155 is disposed to be lower than the lower surface of the floor part 130.

For this reason, the extension 133 protruding downwards is formed at a predetermined portion of the lower surface of the floor part 130 in order to enable the first flange 155 and the lower surface of the floor part 130 to be flush with each other. Therefore, it is preferred that extrusion of the floor part 130 be carried out taking into consideration such a condition.

The extension 133 preferably has a thickness equal to that of the first flange 155 of the side sill 150. As a result, the extension 133 and the first flange 155 of the side sill 150 are disposed on the same plane.

Accordingly, as shown in FIG. 4, welding between the first flange 155 of the side sill 150 and the floor part 130 may be started from the extension 133 of the floor part 130. As a result, airtightness and watertightness of the battery may be secured throughout all sides of the floor part 130.

Meanwhile, although the overall shape of the floor part 130 may be rectangular, it is preferred that the front-end shape of the floor part 130 be quadrangular and the rear-end shape of the floor part 130 be trapezoidal in order to maximally utilize a limited space and, as such, to secure a desired battery capacity.

That is, a rear-side member is coupled to the rear end of the floor 100 of the vehicle body and, as such, the rear end of the floor part 130 protrudes to take a trapezoidal shape in order to mount the battery modules 200 under the condition that even a coupling portion of the rear-side member is utilized.

Of course, as the rear end of the floor part 130 protrudes, an empty space may be formed between the side sill 150 and the barrier wall 131 formed at the rear end of the floor part 130, in detail, at a rear-end edge of the floor part 130. In order to fill the empty space, a seam 500 may be welded at the rear-end edge of the floor part 130.

The seam 500 should also be welded to the lower surface of the floor part 130 in order to secure battery airtightness and watertightness. To this end, the seam 500 also includes a second flange 505 formed at an inner surface of the seam 500 facing the floor part 130. The second flange 550 has the same function as the first flange 155 of the side sill 150.

Accordingly, the second flange 505 surface-contacts the lower surface of the floor part 130 and, as such, may be welded through friction stir spot welding.

Meanwhile, similarly to the extension 133 formed at the lower surface of the floor part 130 adjacent to the front-end barrier wall 131 of the floor part 130, it is preferred that another extension 133 be formed at the lower surface of the floor part 130 adjacent to the rear-end barrier wall 131 of the floor part 130 in order to secure battery airtightness and watertightness.

In detail, welding should be carried out between the side sill 150 and the seam 500 and between the seam 500 and the extension 133 of the floor part 130 in order to secure airtightness and watertightness between the side sill 150 and the seam 500 and between the rear-end barrier wall 131 and the seam 500.

In order to apply friction stir spot welding as a welding method, the extension 133 is formed at the lower surface of the floor part 130 adjacent to the rear-end barrier wall 131 of the floor part 130. When friction stir spot welding is performed up to the extension 133 adjacent to the rear-end barrier wall 131, it may be possible to secure battery airtightness and watertightness.

Similarly to the extension 133 formed at the front end of the floor part 130, the extension 133 formed at the rear end of the floor part 130 has the same thickness as that of the second flange 505 and has the same thickness as that of the first flange 155.

Accordingly, the extension 133 formed at the rear end of the floor part 130, the second flange 505 of the seam 500, and the first flange 155 are disposed on the same plane and, as such, friction stir spot welding may be carried out along the same plane as described above.

The welding direction is determined such that welding is started from the front-end extension 133 of the floor part 130 and is ended at the rear-end extension 133 of the floor part 130. However, the welding direction may be determined such that welding is started from the rear-end extension 133 of the floor part 130 and is ended at the front-end extension 133 of the floor part 130.

That is, friction stir spot welding may be carried out two times at left and right sides of the floor part 130 and, as such, perfect battery airtightness and watertightness may be secured.

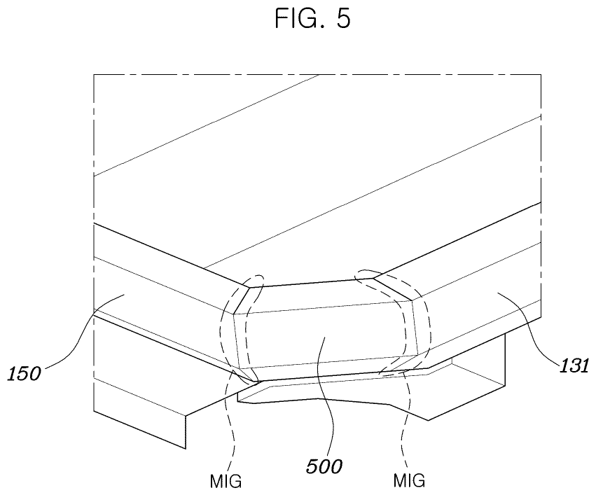

Furthermore, referring to FIG. 5, an area where the seam 500 and the side sill 150 contact each other may be welded through MIG welding, and an area between the seam 500 and the floor part 130 may also be welded through MIG welding. In this case, battery airtightness and watertightness may be further enhanced.

Meanwhile, portions of the upper surface of the side sill 150 and the upper surface of the floor part 130 may be interconnected through a reinforcement 700. Referring to FIGS. 2 and 3, it can be seen that the reinforcement 700 is provided to extend over both the upper surface of the side sill 150 and the upper surface of the floor part 130.

The reinforcement 700 is a member configured to reinforce hardness against a load applied from a side surface of the vehicle and takes the form of a member having a closed cross-section while extending in a predetermined length. A lower surface of the reinforcement 700 is coupled to both the upper surface of the side sill 150 and the upper surface of the floor part 130. In this case, one side surface of the reinforcement 700 surface-contacts the side sill 150 and, as such, is supported by the side sill 150, thereby reinforcing hardness against side collision.

In detail, the upper surface of the floor part 130 is formed to be lower than the upper surface of the side sill 150 when viewed in a height direction. Due to such a structure, a step 153 exposed to the floor part 130 is formed at the upper surface of the side sill 150. Accordingly, the lower surface of the reinforcement 700 may tightly contact the upper surface of the side sill 150 and the upper surface of the floor part 130 disposed at different levels.

Meanwhile, the lower battery case 300, in which the battery modules 200 are mounted, is coupled to the body of the vehicle having the above-described configuration at a lower side. Referring to FIG. 2, a mounting portion, to which the lower battery case 300 will be mounted, is formed at the side sill 150, and the lower battery case 300 is fastened to the mounting portion of the side sill 150 through bolting or the like and, as such, may be fixed to the body of the vehicle.

Meanwhile, a floor part itself may be formed through coupling of extruded members.

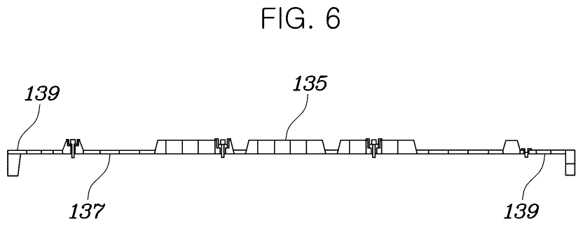

FIG. 6 is a view showing a cross-section taken in a longitudinal direction of a vehicle. Referring to FIG. 6, it can be seen that a floor part is formed through coupling of a plurality of extruded members to one another.

In detail, for formation of a floor part, a plurality of extruded members extruded in a width direction of the vehicle is prepared, and the prepared extruded members are aligned with one another in the longitudinal direction of the vehicle. Adjacent ones of the extruded members are in a state of surface-contacting each other in the width direction of the vehicle. A floor part may be formed through welding of the adjacent extruded members.

In this case, friction stir spot welding is performed to secure airtightness and watertightness of the floor part.

Meanwhile, the plurality of extruded members forming the floor part may include a first extruded member 135, a second extruded member 137, and a third extruded member 139 respectively having different heights.

The first extruded member 135 may extend upwards to a higher level than those of the remaining extruded members. In this case, a seat mounting, to which a seat will be mounted, may be formed at the first extruded member 135.

The third extruded member 139 may extend downwards to a lower level than those of the remaining extruded members. In this case, the third extruded member 139 may be disposed at front and rear ends of the floor part, thereby forming a space at a lower surface of the floor part.

That is, when the first extruded member 135, the second extruded member 137, and the third extruded member 139 are coupled to one another, a space, in which battery modules, etc. will be accommodated, is formed at lower surfaces of a plurality of extruded members, and the third extruded member 139 functions as a barrier wall.

It may be possible to omit an upper battery case in accordance with the body of the vehicle having the above-described configuration and, as such, the weight of the vehicle may be reduced. Although the upper battery case is omitted, airtightness and watertightness of a battery may be secured through welding.

As is apparent from the above description, the vehicle body of embodiments of the present invention has an advantage in that the floor part may function as an upper battery case and as such, it may be possible to achieve lightness through weight reduction by the weight of the upper battery case. In addition, there is an advantage in that the floor part may be welded through friction stir spot welding in order to maintain watertightness/airtightness of a battery while functioning as the upper battery case.

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A body of a vehicle comprising:
a floor part configured as a member molded through an extrusion process, the floor part having a lower surface configured to cover upper portions of battery modules to be accommodated in a lower battery case; and
a pair of side sills coupled to opposite side surfaces of the floor part and extending in a longitudinal direction of the vehicle, each side sill of the pair of side sills comprising a first flange disposed at an inner surface of the side sill facing the floor part and extending in the longitudinal direction, wherein the first flange is directly coupled to the lower surface of the floor part by a first weld.

2. The body of the vehicle according to claim 1, wherein the lower surface of the floor part and the first flange of the side sill are coupled to each other in the longitudinal direction of the vehicle through friction stir spot welding in a surface-contact state.

3. The body of the vehicle according to claim 1, wherein an area between an upper surface of the floor part and an upper surface of the side sill in contact with each other comprises a second weld resulting from metal inert gas welding.

4. The body of the vehicle according to claim 1, wherein portions of an upper surface of the pair of side sills and an upper surface of the floor part are interconnected through a reinforcement.

5. The body of the vehicle according to claim 4, wherein:
the reinforcement comprises a second member having a closed cross-section and extending in a predetermined length;
a lower surface of the reinforcement is coupled to both the upper surface of the pair of side sills and the upper surface of the floor part; and
a first side surface of the reinforcement is in surface-contact with a side sill of the pair of side sills to be supported by the side sill.

6. The body of the vehicle according to claim 5, wherein:
the upper surface of the floor part is disposed lower than the upper surface of the side sill when viewed in a height direction; and
the lower surface of the reinforcement tightly contacts the upper surface of the pair of side sills and the upper surface of the floor part disposed at different levels by a step.

7. The body of the vehicle according to claim 1, wherein:
the floor part is extruded in a width direction of the vehicle;
barrier walls extending downwards are disposed at front and rear ends of the floor part, wherein the barriers walls are integral with the floor part; and
the barrier walls are configured to cover side surfaces of outermost ones of the battery modules.

8. The body of the vehicle according to claim 1, further comprising an extension protruding in a downward direction of the vehicle disposed at the lower surface of the floor part in an area corresponding to an edge of the floor part such that the first flange and the lower surface of the floor part adjacent to the first flange are flush with each other.

9. The body of the vehicle according to claim 8, wherein the extension has a thickness equal to a thickness of the first flange of the side sill.

10. The body of the vehicle according to claim 8, wherein the first weld between the first flange of the side sill and the lower surface of the floor part begins at the extension of the floor part.

11. The body of the vehicle according to claim 1, wherein:
a rear end of the floor part has a trapezoidal shape;
a seam is coupled to the rear end of the floor part at an edge of the floor part by a second weld;
a second flange is disposed at an inner surface of the seam facing the floor part; and
the second flange is coupled to the lower surface of the floor part in a state of contacting the lower surface of the floor part by a third weld.

12. The body of the vehicle according to claim 11, further comprising:
a first extension protruding in a downward direction of the vehicle and disposed at the lower surface of the floor part at a front end of the floor part, the first extension having a lower surface that is flush with lower surfaces of the pair of side sills; and
a second extension protruding in the downward direction of the vehicle and disposed at the lower surface of the floor part at the rear end of the floor part, the second extension having a lower surface that is flush with a lower surface of the second flange of the seam.

13. The body of the vehicle according to claim 12, wherein a thickness of the second flange, a thickness of the second extension at the rear end of the floor part, and a thickness of the first flange of the pair of side sills are equal.

14. The body of the vehicle according to claim 12, wherein the first weld between the first flange of the side sill and the lower surface of the floor part starts at the first extension of the floor part and ends at the second extension of the floor part.

15. The body of the vehicle according to claim 11, wherein:
an area between the seam and the side sill contacting each other and an area between the seam and a barrier wall of the floor part are coupled by a metal inert gas weld; and
the lower surface of the floor part and the second flange are coupled to each other by a friction stir spot weld.

16. A body of a vehicle comprising:
a floor part comprising a plurality of extruded members extruded in a width direction of the vehicle and aligned with one another in a longitudinal direction of the vehicle, the floor part having a lower surface configured to cover upper portions of battery modules to be accommodated in a lower battery case; and
a pair of side sills coupled to opposite side surfaces of the floor part and extending in the longitudinal direction of the vehicle, each side sill of the pair of side sills comprising a first flange disposed at an inner surface of the side sill facing the floor part and extending in the longitudinal direction, wherein the first flange is directly coupled to the lower surface of the floor part by a first weld.

17. The body of the vehicle according to claim 16, wherein adjacent ones of the extruded members are coupled to each other through friction stir spot welds in a state of surface-contacting each other to define the floor part.

18. The body of the vehicle according to claim 16, wherein:
the plurality of extruded members comprises a first extruded member, a second extruded member, and a third extruded member respectively having different heights;
a seat mounting is disposed at the first extruded member extending upwards to a higher height than the heights of the second and third extruded members; and
the third extruded member extends downward to a lower height than the heights of the first and second extruded members and is disposed at front and rear ends of the floor part to define a space at the lower surface of the floor part.

19. The body of the vehicle according to claim 16, wherein:
a rear end of the floor part has a trapezoidal shape;
a seam is coupled to the rear end of the floor part at an edge of the floor part by a second weld;
a second flange is disposed at an inner surface of the seam facing the floor part; and
the second flange is coupled to the lower surface of the floor part in a state of contacting the lower surface of the floor part by a third weld.

20. The body of the vehicle according to claim 19, wherein:
an area between the seam and the side sill contacting each other and an area between the seam and a barrier wall of the floor part are coupled by a metal inert gas weld; and
the lower surface of the floor part and the second flange are coupled to each other by a friction stir spot weld.
